(19) United States
(12) Patent Application Publication
(10) Pub. No.: US 2020/0149743 A1
(43) Pub. Date: May 14, 2020

(54) ROTATING DETONATION COMBUSTOR WITH THERMAL FEATURES

(71) Applicant: General Electric Company, Schenectady, NY (US)

(72) Inventors: Kapil Kumar Singh, Rexford, NY (US); Narendra Digamber Joshi, Schenectady, NY (US); Thomas Michael Lavertu, Ballston Lake, NY (US); Thomas Earl Dyson, Niskayuna, NY (US); Andrew Thomas Cross, Waterford, NY (US)

(73) Assignee: General Electric Company, Schenectady, NY (US)

(21) Appl. No.: 16/185,208

(22) Filed: Nov. 9, 2018

(51) Int. Cl. F23R 3/00; F23R 3/50

(52) U.S. Cl. CPC F23R 3/005; F05D 2260/201; F05D 2240/35; F23R 3/50

(57) ABSTRACT

A combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; and at least one cooling feature disposed at an underside of the inner wall or the outer wall. The cooling feature maintains a temperature of the inner wall or the outer wall within a predetermined range.

### BACKGROUND

The present subject matter relates generally to a combustor of an engine, such as a rotating detonation engine.

A rotating detonation engine includes an annulus with an inlet end through which a fuel and air mixture enters and an outlet end from which exhaust exits. A detonation wave travels in a circumferential direction of the annulus and consumes the incoming fuel and air mixture. The burned fuel and air mixture (e.g., combustion gases) exits the annulus and is exhausted with the exhaust flow.

The detonation wave provides a high-pressure region in an expansion region of the combustion system. Rotating detonation pressure gain combustion systems are expected to operate at much higher frequencies than other pressure gain combustion concepts such as pulse detonation combustors.

Maintaining a rotating detonation wave within rotating detonation combustors during low power conditions of the engines, as well as selectively controlling and/or adjusting the operating conditions present technical challenges. For example, when a rotating detonation engine is operating at an idle condition (e.g., not generating enough propulsive force to propel the engine or a vehicle that includes the engine), the detonations rotating within the combustor of the engine may dissipate or be extinguished.

### BRIEF DESCRIPTION OF THE EMBODIMENTS

Aspects of the present embodiments are summarized below. These embodiments are not intended to limit the scope of the present claimed embodiments, but rather, these embodiments are intended only to provide a brief summary of possible forms of the embodiments. Furthermore, the embodiments may encompass a variety of forms that may be similar to or different from the embodiments set forth below, commensurate with the scope of the claims.

In one aspect, a combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; and at least one cooling feature disposed at an underside of the inner wall or the outer wall. The cooling feature maintains a temperature of the inner wall or the outer wall within a predetermined range.

In another aspect, a combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; at least one fuel injector disposed proximate the inlet end; and at least one anti-coking feature disposed proximate the inlet end.

In another aspect, a combustion system includes an annular tube disposed between an inner wall and an outer wall, the annular tube extending from an inlet end to an outlet end; at least one fluid inlet disposed in the annular tube proximate the inlet end, the fluid inlet providing a conduit through which fluid flows into the annular tube; at least one outlet disposed in the annular tube proximate the outlet end; at least one mounting spring disposed proximate the outlet end.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective schematic representation of a rotating detonation combustor; and

FIG. 2 is a side schematic representation of a rotating detonation combustor; and

FIG. 3 is an aft-looking forward view of a rotating detonation combustor, according to aspects of the present embodiments.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “axial” refers to a direction aligned with a central axis or shaft of a gas turbine engine or alternatively the central axis of a propulsion engine, a combustor, and/or internal combustion engine. An axially forward end of the gas turbine engine or combustor is the end proximate the fan, compressor inlet, and/or air inlet where air enters the gas turbine engine and/or the combustor. An axially aft end of the gas turbine engine or combustor is the end of the gas turbine or combustor proximate to the engine or combustor exhaust where combustion gases exit the engine or combustor. In non-turbine engines, axially aft is toward the exhaust and axially forward is toward the inlet.

As used herein, the term “circumferential” refers to a direction or directions around (and tangential to) the circumference of an annulus of a combustor, or for example the circle defined by the swept area of the turbine blades. As used herein, the terms “circumferential” and “tangential” are synonymous.

As used herein, the term “radial” refers to a direction moving outwardly away from the central axis of the gas turbine, or alternatively the central axis of a propulsion engine. A “radially inward” direction is aligned toward the central axis moving toward decreasing radii. A “radially outward” direction is aligned away from the central axis moving toward increasing radii.

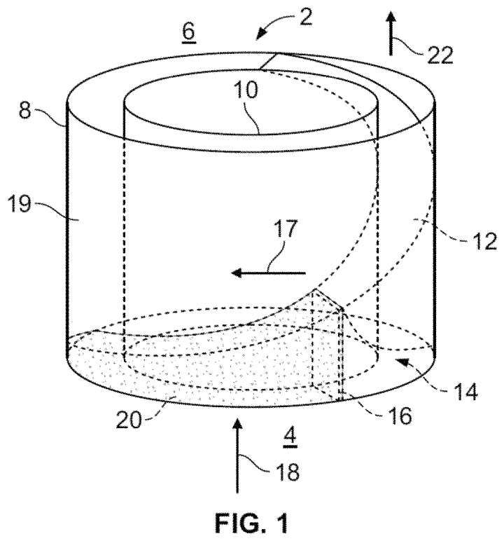

FIG. 1 illustrates a schematic diagram of one example of a rotating detonation combustor 2. The combustor 2 includes an annular combustor formed from an outer wall 8 and an inner wall 10. The combustor that is defined by the walls 8, 10 has an inlet end 4 (in which a fuel/air mixture 18 enters) and an outlet end 6 from which an exhaust flow 22 exits the combustor 2. A detonation wave 16 travels in a circumferential direction 17 of the annulus (and around an annular axis of the annulus), thereby consuming the incoming fuel/air mixture 18 and providing a high-pressure region 14 in an expansion region 12 of the combustor 2. The burned fuel/air mixture (e.g., combustion gases) 19 exit the annulus and are exhausted as the exhaust flow 22. The region 20 behind the detonation wave 16 has very high pressures and this pressure can feed back into an upstream chamber from which the air and fuel are introduced and form an unburnt fuel/air mixture 18. Thermally managing the temperatures and thermal gradients within and around the combustor 2 may enhance the durability, operability, and/or overall performance of the combustor 2.

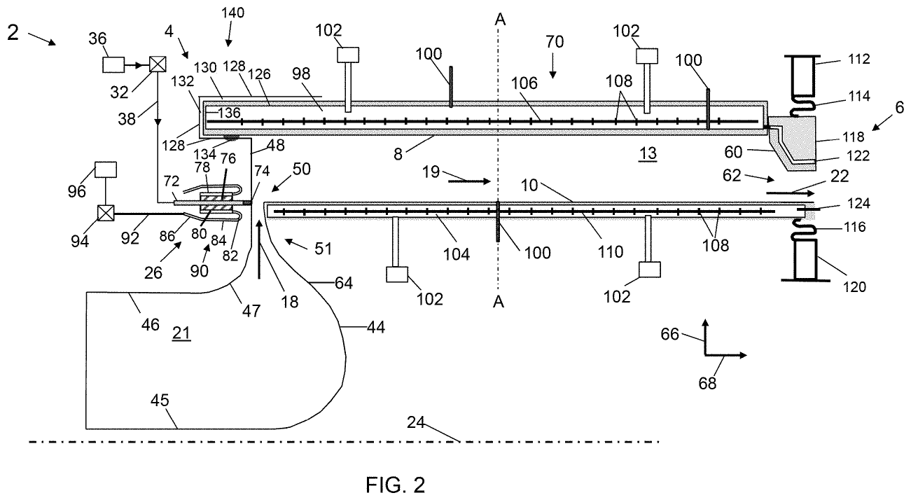

FIG. 2 illustrates a side view of a rotating detonation combustor 2 according to the embodiments disclosed herein. The combustor 2 includes a combustion tube (or annular tube) 70 extending between an inlet end 4 and an outlet end 6. The inlet end 4 includes a combustor forward wall 48 while the outlet end 6 includes a combustor aft wall 60. An annulus 13 is defined between the inner wall 10, the outer wall 8, the combustor forward wall 48, and the combustor aft wall 60. The annulus 13 is an annular ring, axisymmetric about a combustor centerline 24. A side view of the annulus 13 is depicted in FIG. 2, however, the annulus 13 extends circumferentially 360 degrees about the combustor centerline 24. The combustor centerline 24 may be colinear and/or overlapping with an engine centerline. An incoming fluid 18 (i.e., air, oxidizer, and/or fuel/air mixture) enters the annulus 13 at an air inlet 50 proximate the inlet end 4. At least one igniter (not shown) may be disposed in the inner wall 10 and/or at the outer wall 8 at the inlet end 4 of the combustor 2, for igniting the fuel/air mixture 18. A combustor exhaust 62 is disposed at an axially downstream end of the annulus 13 proximate the outlet end 6. Combustion gas 19 travels in an axially aft and circumferential direction toward the outlet end 6, where exhaust gas 22 is dispersed through the combustor exhaust 62.

FIG. 2 illustrates an axial direction 68 and a radial direction 66. The axial direction 68 illustrated in FIG. 2 is oriented in an axially aft direction, while the radial direction 66 is oriented in a radially outward direction. An axially forward direction (not shown) is the opposite direction of the axial direction 68 (or axially aft direction) illustrated in FIG. 2. Similarly, a radially inward direction (not shown) is the opposite direction of the radial direction 66 (or radially outward direction) illustrated in FIG. 2. A circumferential or tangential direction is into or out of the plane of the figure (i.e., “into the page”) and is orthogonal to both the radial and axial directions. An air inlet plenum 21 is coupled fluidly upstream of the air inlet 50, for delivering air, oxidizer, fluids, and/or fuel-air mixtures to the annulus 13. The air inlet plenum 21 may also be described as a fluid inlet plenum 21 because according to the embodiments described herein, fluids other than air may flow through the fluid/air inlet plenum 21. The air inlet plenum 21 receives a working fluid (air, an oxidizer, and/or fuel-air mixtures) from an air supply or oxidizer supply (not shown). The air and/or oxidizer may be pressurized prior to entering the air inlet plenum 21 via a compressor (not shown), ram effects, and/or via other means.

The air inlet plenum 21 is defined within a first sidewall 46 (that defines a radially outer boundary of the air inlet plenum 21), a second sidewall 45 (that defines a radially inner boundary of the air inlet plenum 21), and a plenum backwall 44 which defines an axially aft boundary of the air inlet plenum 21. Each of the first and second sidewalls 45, 46 are oriented in an axial or substantially axial direction. The plenum backwall 44 transitions the air inlet plenum 21 from an axial direction 68 to a radial direction 66 at a location that is approximately equidistance between the first and second sidewalls 45, 46. The plenum backwall 44 includes a curved or contoured surface which, at a radially inward portion, is concave toward an axially forward end of the air inlet plenum 21. The contouring of the plenum backwall 44 gradually transitions from a pure axial orientation at the second side wall 45 to a pure radial direction at the combustor centerline 24. The contouring of the plenum backwall 44 continues to be concave toward an axially forward end of the combustor, past the radial direction such that the plenum backwall 44 curves back toward an axially forward end of the air inlet plenum 21. The plenum backwall 44 reaches an inflection point 64 where the curvature begins to curve back toward a pure radial direction. The plenum backwall 44 is oriented in a pure radial direction at the intersection with the annulus inner wall 10, which also coincides with the radial location of a minimum flow area of the air inlet 50.

Referring still to FIG. 2, the air inlet plenum 21 includes a transition portion 47 which forms a transition from the first sidewall 46 to the combustor forward wall 48. The combustor forward wall 48 may be oriented in a radial or substantially radial direction. The transition portion 47 includes contouring that curves from an axial direction at the intersection with the first sidewall 46, to a radial direction at the intersection with the combustor forward wall 48. Inlet air (or oxidizer and/or other fluid) 18 may be travelling in an axial direction at an axially forward portion of the air inlet plenum 21. The direction of the inlet air (or oxidizer or other fluid) 18 flowing through the air inlet plenum 21 may transition from an axial direction 68 to a radial direction 66 (with a possible component of the airflow direction in the circumferential direction as well) as the air approaches the air inlet 50. The radially outer portions of each of the transition portion 47 and the plenum backwall 44 collectively form a throat portion 51 through which air and/or oxidizer (or other fluid) flows prior to entering the annulus 13 via the air inlet 50. The throat portion 51 may include a smaller flow area than both the air inlet plenum 21 and the annulus 13. The embodiment of FIG. 2 illustrates the combustor 2 including a radial air inlet 50, because air (and/or oxidizer) travels radially outward from the plenum 21 into the annulus 13. However, in other configurations of the present claimed embodiments, the combustor 2 may include an axial inlet where air enters the annulus 13 at an axially forward end while travelling in an axial direction. (For example, in an axial inlet configuration, the air inlet 50 may be disposed within the combustor forward wall 48).

Still referring to FIG. 2, one or more primary fuel injectors 26 may be disposed in the combustor forward wall 48 at a radial location corresponding to the air inlet 50. The one or more primary fuel injectors 26 may include a fuel nozzle 74 that may be disposed in the combustor forward wall 48 at a location that is approximately axially forward of the inner wall 10. The primary fuel injector 26 disperses fuel via the fuel nozzle 74 into the inlet air 18 as inlet air enters the combustor tube 70 at the air inlet 50. The primary fuel injector 26 may disperse fuel in an axial direction, orthogonal to the direction of the inlet air, which flows into the annulus in a radially outward direction. In other embodiments, (for example in embodiments with an axial inlet), the primary fuel injector 26 may disperse fuel in a radial direction 66. A first fuel line 38 is fluidly coupled to the one or more primary fuel injectors 26 for delivering fuel to the one or more primary fuel injectors 26. A first fuel control valve 32 is fluidly coupled upstream of the first fuel line 38. A fuel supply 36 is fluidly coupled upstream of the first fuel control valve 32.

The combustor 2 may include a fuel plenum 72 disposed fluidly upstream of the fuel nozzle 74, and downstream of the first fuel line 38. The fuel plenum 72 and fuel nozzle 74 may be colinear. Stated otherwise, each of the fuel plenum 72 and the fuel nozzle 74 may include a tube-like (cylindrical) central body which may both collectively be aligned along a central longitudinal axis of the fuel injector 26. The fuel injector 26 may include an air swirler 76 disposed around (i.e., radially outward of) the fuel plenum 72. The air swirler 76 may include a radially outward outer manifold 78 and at least one swirl fin 80. A circumferential air plenum 90 may be disposed radially outward of both of the air swirler 76 and fuel plenum 72 and may be fluidly coupled to the outer manifold 78. The circumferential air plenum 90 may include a rounded end potion 82 disposed axially aft of, and fluidly connected to, the outer manifold 78. The rounded end portion 82 may form an annular flow passage that delivers air radially inward toward both the fuel plenum 72 and air swirler 76. The circumferential air plenum 90 may also include a longitudinal portion 84 disposed axially forward of a radially outer portion of the rounded end portion 82. The longitudinal portion 84 may be aligned axially and may be fluidly coupled upstream of the rounded end portion 82. The circumferential air plenum 90 may also include a tapered portion 86 disposed axially forward of, and coupled fluidly upstream of, the longitudinal portion 84. The tapered portion 86 may taper radially outward as it transitions axially afterward.

A cooling air line 92 may be fluidly coupled upstream of the tapered portion 86 for delivering cooling air to the circumferential air plenum 90 and primary fuel injector 26. The combustor may also include an air flow actuator 94 disposed upstream of the cooling air line 92, as well as an air supply 96 disposed upstream of the air flow actuator 94, which may be used to selectively control the amount of air flowing to the circumferential air plenum 90. In operation, cooling air may flow from the cooling air supply 96 to the air swirler 76 via the circumferential air plenum 90. Once in the air swirler 76, air may flow through the one or more swirl fins (or vanes) 80, impinging on the fuel plenum 72, thereby by serving to regulate the temperature of the fuel within the fuel plenum 72, as well as the immediate vicinity surrounding the fuel injector 26. By maintaining temperatures and thermal gradients within a desired range, the circumferential air plenum 90 and air swirler 76 may collectively act as anti-coking features, thereby reducing or eliminating the accumulation of coke in the primary fuel injector 26 and components thereof. Other configurations of the primary fuel injector 26 and fuel plenum 72 according to the embodiments disclosed herein may include other arrangements for actively cooling and/or thermally managing the heat loads in and around the primary fuel injector 26. In another embodiment, there may not be any cooling flow and the air supply line 92, the air flow control valve 94, and the air supply 96 may all be absent. In this embodiment the fuel fills the cavities 86, 84, 82, 78, and 76. The stagnant fuel in these cavities cokes up and becomes a thermal barrier to the fuel in 72 and 74 and acts as anti-coking feature. As such, the circumferential air plenum 90 may also (or instead) act as a circumferential fuel plenum 90, for preventing or reducing the build-up of coke, as described above.

Referring still to FIG. 2, one or more secondary, tertiary, and/or auxiliary fuel injectors (not shown) may also be disposed within various walls and/or structures of the combustor 2. Each of the inner and outer walls 10, 8 may include cooling features disposed therein. In an exemplary embodiment, an outer air plenum 98 may be disposed within the outer wall 8, while an inner air plenum 104 may be disposed within the inner wall 10. The outer and inner air plenums 98, 104 may include outer and inner impingement plates (or baffles) 106, 110 aligned axially for directing cooling air onto the underside (i.e., the side opposite the portion defining the boundary of the annulus 13) of each of the inner wall 10 and outer wall 8. Each of the inner and outer impingement plates 110, 106 may include a plurality of holes or jets 108 disposed within and spaced axially along the inner and outer impingement plates 110, 106 for directing cooling air onto the underside of each of the inner wall 10 and outer wall 8. One or more cooling air supplies 102 may be fluidly coupled to each of the inner and outer air plenums 98, 104 for supplying cooling air thereto. Each of the inner and outer impingement plates 110, 106 may circumferentially extend around the centerline 24 contouring to match the circumferential contouring of each of the inner and outer walls 10, 8. The inner and outer impingement plates 110, 106 may each form individual arc-segments that collectively extending 360 degrees around and/or radially inward of the annulus 13. Embodiments disclosed herein may include 2, 4, 6, 8, 9, 10, 12, 14, 16, 18, 20, 30, 40, 50, and/or other numbers of individual segments forming each of the inner and outer impingement plates 110, 106. Each of the inner and outer impingement plates 110, 106 may include a concave contouring that is oriented radially inward. As such, the inner impingement plate 110 may include a concave contouring that is oriented away from the inner wall 10 while the outer impingement plate 106 may include a concave contouring that is oriented toward the outer wall 8.

Still referring to FIG. 2, in embodiments which include a plurality of holes and/or jets 108 (coolant-directing features in contact with or integral to the impingement plate), cooling air may flow through the plurality of holes and/or jets 108 and impinge onto the underside of each of the inner wall 10 and outer wall 8. In embodiments which include a plurality of jets 108, each of the jets 108 may protrude radially toward the target surface from the respective inner and/or outer impingement plates 110, 106. The inner and outer impingement plates 110, 106 may extend circumferentially within the radial interior of the annulus 13 (i.e., with respect to the inner impingement plate 110), and/or around the outside of the annulus 13 (i.e., with respect to the outer impingement plate 106). The plurality of jets 108 may be arranged in axial rows that are circumferentially spaced around and/or within the annulus 13. In some embodiments each axial row of jets or holes may be circumferentially aligned with an adjacent axial row of jets and/or holes. In other embodiments, each axial row of jets or holes may be circumferentially offset from an adjacent axial row of jets and/or holes. In embodiments which include a plurality of jets 108, each of the jets 108 may also act as turbulence promoters or turbulators, thereby enhancing heat transfer as air flows between each jet and the underside of each of the inner wall 10 and outer wall 8. Other configurations according to the present disclosed embodiments may include other suitable means of cooling the underside of each of the inner wall 10 and outer wall 8.

Referring still to FIG. 2, the combustor aft wall 60 may be oriented in a radial direction and/or may be oriented to have components in both the radial and axial directions, as illustrated in FIG. 2. For example, the combustor aft wall 60 may be oriented from about 0 to about 30 degrees from a radial direction. In other embodiments, the combustor aft wall 60 may be oriented from about 5 to about 25 degrees from a radial direction. In other embodiments, the combustor aft wall 60 may be oriented from about 10 to about 20 degrees from a radial direction. In other embodiments, the combustor aft wall 60 may be oriented from about 12 to about 18 degrees from a radial direction. The combustor aft wall 60, in concert with the aft end of the inner wall 10, forms the combustor exhaust 62, through which the exhaust flow 22 flows. The combustor exhaust 62 is disposed in a radial gap between the radially inner end of the combustor aft wall 60 and the axially aft end of the inner wall 10. The radial gap extends 360 degrees around the annular combustor 2, axisymmetric or substantially axisymmetric about the combustor centerline 24. The radial gap that defines the combustor exhaust 62 may span a greater or smaller linear distance than the axial gap that the defines the air inlet 50. Similarly, the flow area of the combustor exhaust 62 may be greater or less than the flow area of the air inlet 50.

Still referring to FIG. 2, an outer cooling passage 122 may be disposed proximate the combustor aft wall 60 fluidly connecting the outer air plenum 98 to an exterior of the combustor 2. The combustor aft wall 60 may be disposed within an exhaust frame 118, disposed at the aft end 6 of the combustor 2. The outer cooling passage 122 may be disposed within the exhaust frame 118. The outer cooling passage 122 may cool the combustor aft wall 60 and/or the exhaust module 118, and also may provide a passage through which air entering the outer air plenum 98 may exit. An inner cooling passage 124 may fluidly connect the inner air plenum 104 to an exterior of the combustor 2. The inner cooling passage 124 may be disposed within an aft end of the other wall 10, and may provide a passage through which air entering the inner air plenum 104 may exit.

At the aft end 6 of the combustor, an inner mounting spring 116 may be disposed radially inward of the inner wall 10 while an outer mounting spring 114 may be disposed radially outward of the exhaust frame 118. The inner mounting spring 116 may be mechanically coupled to an aft end of the inner wall 10 as well as to an inner hard mount 120, disposed radially inward of the inner mounting spring 116. The outer mounting spring 114 may be mechanically coupled to a radially outward portion of the exhaust frame 118 as well as to an outer hard mount 112, disposed radially outward of the outer mounting spring 114. Each of the inner and outer mounting springs 114, 116 may extend circumferentially 360 degrees around the centerline 24 and may include at least one s-shaped portion. In other embodiments, each of the inner and outer mounting springs 114, 116 may c-shaped, u-shaped and/or other shaped cross sections. In operation, each of the inner and outer mounting springs 114, 116 may allow for thermal growth (i.e., thermal expansion and/or thermal contraction) along each of the axial and radial direction 68, 66. As such, each of the inner and outer mounting springs 114, 116 may also be considered to be thermal expansion features.

FIG. 2 also illustrates a plenum boundary wall 126 disposed radially outward of the outer wall 8. The plenum boundary wall 126 and the outer wall 8 collectively define the radially outer and radially inner walls of the outer air plenum 98. At the forward end 4, the air plenum 98 may be disposed within a forward hard mount 128. A radial gap 130 is disposed between the forward hard mount 128 and the plenum boundary wall 126. Similarly, an axial gap 132 is disposed between the forward hard mount 128 and the forward wall 136 of the outer air plenum 98. At an axially forward portion of the outer wall 8, a seal 134 (and/or bearing, c-ring, w-ring, u-ring, piston-ring and/or O-ring) may be disposed between the outer wall 8 and the forward hard mount 128. The radial and axial gaps 130, 132 allow for thermal expansion in each of the radial and axial directions. The seal 134 may simultaneously support the forward end of the outer air plenum 98 (allowing for movement in each of the axial and radial directions) while also fluidly sealing the annulus 13. The plenum boundary wall 126, the outer wall 8, the radial gap 130, the axial gap 132, and the forward hard mount 128 collectively define a forward expansion joint 140, allowing for radial and axial expansion at the forward end of the combustor 2.

Still referring to FIG. 2, at least one tangential probe 100 may be disposed within the inner wall 10, the outer wall 8, the plenum boundary wall 126, as well as within other surfaces and/or structures of the combustor 2. Each tangential probe 100 may be aligned at least partially in a tangential or circumferential direction. (In the illustration of FIG. 2, alignment of the tangential probes(s) 100 in a tangential and/or circumferential direction is not illustrated). By aligning the tangential probe(s) 100 at least partially tangentially, thermal gradients along the probe may be reduced due to the average distance between points along the tangential probe 100 being decreased and therefore bringing the probe closer to a heat source at the tip of the tangential probe 100. Stated otherwise, tangentially aligned probes 100, as a whole, will be closer to a radially inner or outer heat source than radially aligned probes (not shown) which are oriented orthogonal to the heat source. In addition, as tangential probes 100 expand along their respective lengths due to thermal expansion, they will expand tangentially away rather than radially away, thereby remaining closer to the heat source and/or measurement location and thus also allow for a more robust thermomechanical design and durability. Tangential probes 100 may include temperature probes, static pressure sensors, dynamic pressure sensors, differential pressure sensors, oxygen sensors, and/or other types of sensors.

The primary fuel injector 26, as well as any other fuel injectors, may disperse fuel through holes and/or orifices that are circular, elliptical, slotted, and/or other suitable shapes. A minimum dimension (i.e., diameter, width, minor axis, etc.) of the holes and/or orifices in each of the primary fuel injector 26 and/or other fuel injectors may be from about 3 to about 30 mils (i.e., thousandths of an inch). In other embodiments, the minimum dimension of the holes and/or orifices may be from about 5 to about 20 mils. In other embodiments, the minimum dimension of the holes and/or orifices may be from about 8 to about 17 mils. In other embodiments, the minimum dimension of the holes and/or orifices may be from about 10 to about 15 mils.

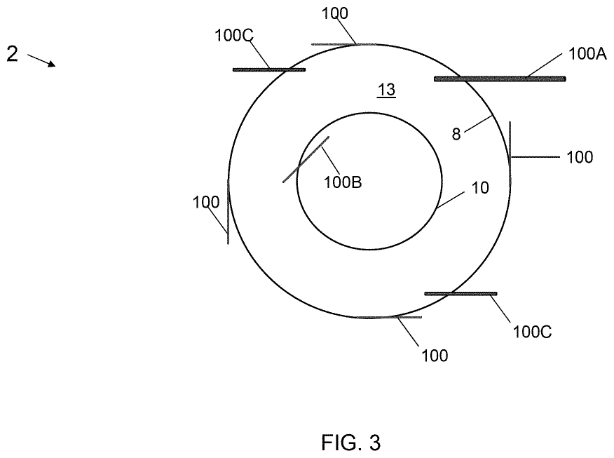

FIG. 3 illustrates an aft-looking forward view of the combustor 2 including multiple tangential probes 100 disposed within the inner wall 10 and/or the outer wall 8. The combustor 2 may include multiple tangential probes 100 disposed circumferentially around the annulus 13 (which may be tangentially aligned with the outer wall 8), as well as at least one larger tangential probe 100A disposed through the outer wall 8 and/or the inner wall 10. The combustor may also include one or more tangential probes 100B disposed through the inner wall 10, as well as at least one tangential probe 100C disposed through the outer wall 8. The tangential probes 100, 100A, 100B, 100C illustrated in FIGS. 2 and 3 may include temperature probes, static pressure sensors, dynamic pressure sensors, differential pressure sensors, oxygen sensors, and/or other types of sensors.

A rotating detonation wave resulting from combustion of a fuel-air mixture from the one or more primary fuel injectors 26 and/or air inlet 50 may travel circumferentially around the combustor 2 as it travels the axial length of the combustor tube (or annular tube) 70, from the inlet end 4 to the outlet end 6. The magnitude of the rotating detonation wave may begin to dissipate as it propagates circumferentially and axially through the combustor 2. Maintaining consistent and/or controllable temperature profiles and gradients throughout the volume of the combustor 2, and components and/or structures thereof may enhance the stability of the rotating detonation wave during operation. As such, the tangential probe(s) 100, the cooling features on the inner and outer walls 10, 8, the cooling passages 122, 124 at the aft end 6, the aft mounting springs 114, 116, the forward hard mount 128, and the anti-coking features associated with the primary fuel injector(s) 26, all allow the combustor 2 to remain in stable operation while simultaneously managing the thermal loads and gradients, as well as allowing for thermal expansion of components of the combustor 2.

In operation, each of the embodiments disclosed herein may include multiple detonation waves simultaneously propagating in a circumferential (and axially aft) direction such that they wrap around the annulus 13 as they move from an inlet end 4 to an outlet end 6. Chemistry and combustor dynamics, as well as other factors, may limit the minimum size of both the combustor 2 as well as the area and/or volume of the annulus 13 due to a minimum amount of time required for the rotating denotation wave to travel around the annulus. As such, the area of the annulus 13, the overall radius of the combustor 2, and/or the overall axial length of the combustor 2 may all be adjusted to ensure the chemistry considerations as well as other factors such as combustor dynamics, aerodynamics, thermal management, and other considerations are all balanced accordingly. In addition, it may be desirable for the combustor 2 to have a non-circular shape in order to increase the distance around the annulus 13 that the rotating detonation wave may travel, while simultaneously allowing the axial length of the combustor 2 to be decreased.

Each of the embodiments disclosed herein may include at least one igniter, at least one radial and/or axial air inlet (as well as inlets that are partially radially, axially and/or tangentially (i.e., circumferentially) aligned), an annular, cylindrical and/or ring-shaped fuel manifold, at least one manifold supply line and/or fluid coupling to each of the first, second, and third fuel supply lines 38, 40, 42, as well as other upstream system components such as an air (or oxidizer) supply, an airflow (or oxidizer flow) control mechanism, as well as other upstream system components. Each of the fuel injectors and/or fuel holes may be spaced and sized to: enhance mixing by increasing mixing resonance time, adapt to varying pressure pulses within the annulus 13 through varying fuel stiffness (varying impedance), ensure proper spatial equivalence ratios to boost pressure gain performance, and/or increase regularity of pressure pulse performance. By actively and/or passively controlling the thermal gradients and temperature ranges within and around the combustor 2, the present embodiments may prevent successive rotating detonation waves from weakening, strengthening uncontrollably, and/or ceasing from detonating entirely. The present claimed embodiments allow equivalence ratios, resonance times, pressure gradients, temperature ranges, thermal gradients, as well as other factors to balance throughout the entire volume of the annular combustor 2.

As used herein, “detonation” and “quasi-detonation” may be used interchangeably. Typical embodiments of detonation chambers include a means of igniting a fuel/oxidizer mixture, for example a fuel/air mixture, and a confining chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, autoignition or by another detonation via cross-firing. The geometry of the detonation chamber is such that the pressure rise of the detonation wave expels combustion products out of the detonation chamber exhaust to produce a thrust force, as well as for other purposes such as flow control actuation. In addition, rotating detonation combustors are designed such that a substantially continuous detonation wave is produced and discharged therefrom. Detonation may be accomplished in a number of types of detonation chambers, including detonation tubes, shock tubes, resonating detonation cavities, and annular detonation chambers.

Each of the embodiments disclosed herein include fuel being combusted in the presence of an oxidizer. Fuel mixes with an oxidizer during or prior to the combustion process. The embodiments disclosed herein include air as one possible oxidizer. However, other oxidizers such as straight oxygen (i.e., pure oxygen) are also possible. In various conditions, oxygen may be a preferred oxidizer over air. In other conditions, air may be the preferred oxidizer. As used herein, the terms “oxygen” and “pure oxygen,” may include gas that is at least about 80% oxygen by mass. In some embodiments, the oxidizer may be at least about 90% oxygen by mass. In other embodiments, the oxidizer may be about 93% to about 99.3% oxygen by mass. In other embodiments, the oxidizer may be greater than about 99.3% oxygen by mass. (By comparison, air is about 21% oxygen, about 78% nitrogen and about 1% other gases). Other oxidizers other than oxygen and air are also possible. In embodiments that use an oxidizer other than air, those embodiments will include the corresponding system components including, for example, an oxidizer inlet, an oxidizer supply line, an oxidizer supply, an oxidizer flow control mechanism, an oxidizer flow modulator, and/or a second oxidizer inlet.

Each of the embodiments disclosed herein include a source of ignition, which may be in the form of a spark igniter and/or via autoignition (i.e., via heated inner and outer walls 10, 8, and/or heated combustor forward wall 48, hood outer wall 52, which have absorbed heat from the combustion process), as well as via volumetric ignition. Some embodiments may include multiple sources of ignition. For example, in some embodiments, at least one spark igniter may be used during some operating conditions and then ignition may transition to autoignition and/or volumetric ignition at other operating conditions.

The present embodiments include an aircraft, an engine, a combustor, and/or systems thereof which include rotating detonation combustion. The embodiments presented herein operate on a kilohertz range (1000 Hz to 1000 kHz), which is faster than the 100 Hz operating frequency of previous pulse detonation actuators (PDA) and/or pulse detonation engines (PDE). As such, the embodiments presented herein may provide a more continuous and less pulsed combustion gas jet discharging from the combustor exhaust 62 compared to previous pulse detonation actuators (PDA).

The present embodiments offer both high operating frequency and significant control authority, which provides benefits in numerous practical applications, such as engine exhaust thrust vectoring for vehicle control or boundary layer separation control for aircraft lift enhancement and drag reduction. The present embodiments may also be used as enhancements or combustion systems for supersonic and/or hypersonic applications, for example, in scramjet engines. The present embodiments take advantage of a more compact and/or power dense combustion system. The present embodiments may be used as the primary combustion system for engines such as gas turbine engines. The present embodiments may be used as the secondary, tertiary, and/or auxiliary combustion systems for engines such as gas turbine engines, and/or other components of an aircraft or of other applications.

Exemplary applications of the present embodiments may include high-speed aircraft, separation control on airfoils, flame holders, flame stability, augmenters, propulsion, flight stability, flight control, as well as other uses.

Although specific features of various embodiments of the present disclosure may be shown in some drawings and not in others, this is for convenience only. In accordance with the principles of the present disclosure, any feature of a drawing may be referenced and/or claimed in combination with any feature of any other drawing.

This written description uses examples to disclose the embodiments of the present disclosure, including the best mode, and also to enable any person skilled in the art to practice the disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A combustion system comprising:
an annular tube disposed between an inner wall and an outer wall, the annular tube extending from an inlet end to an outlet end;
at least one fluid inlet disposed in the annular tube proximate the inlet end, the at least one fluid inlet providing a conduit through which fluid flows into the annular tube;
at least one outlet disposed in the annular tube proximate the outlet end; and
at least one cooling feature disposed at an underside of at least one of the inner wall and the outer wall, the at least one cooling feature for maintaining a temperature of at least one of the inner wall and the outer wall within a predetermined range.

2. The combustion system of claim 1, further comprising:
at least one air plenum disposed at an underside of at least one of the inner wall and the outer wall; and
at least one impingement plate disposed within the at least one air plenum,
wherein at least one cooling feature is disposed within the at least one impingement plate.

3. The combustion system of claim 2, the at least one impingement plate further comprising:
an inner impingement plate disposed radially inward of the inner wall; and
an outer impingement plate disposed radially outward of the outer wall.

4. The combustion system of claim 2, wherein the at least one impingement plate further comprises at least one cooling hole disposed therethrough.

5. The combustion system of claim 4, wherein the at least one cooling hole further comprises multiple axial rows of cooling holes, and
wherein each axial row of cooling holes is circumferentially aligned with an adjacent axial row of cooling holes.

6. The combustion system of claim 4, wherein the at least one cooling hole further comprises multiple axial rows of cooling holes, and
wherein each axial row of cooling holes is circumferentially offset from an adjacent axial row of cooling holes.

7. The combustion system of claim 2 further comprising:
at least one outer cooling passage disposed at the outlet end;
the at least one air plenum further comprising an outer air plenum,
wherein the at least one outer cooling passage fluidly connects the outer air plenum to an exterior of the combustor.

8. The combustion system of claim 2 further comprising:
at least one inner cooling passage disposed at the outlet end;
the at least one air plenum further comprising an inner air plenum,
wherein the at least one inner cooling passage fluidly connects the inner air plenum to an exterior of the combustor.

9. The combustion system of claim 1 further comprising: at least one expansion joint disposed at the inlet end of the combustor.

10. The combustion system of claim 9, wherein the at least one expansion joint allows for at least one of radial expansion of the outer wall and axial expansion of the outer wall.

11. The combustion system of claim 9, further comprising at least one of:
at least one seal disposed radially inward of the outer wall at a forward end;
at least one forward hard mount defined around the outer wall at the forward end;
at least one axial gap defined between the outer wall and a surrounding surface; and
at least one radial gap defined between the outer wall and a surrounding surface.

12. The combustion system of claim 1 further comprising: at least one tangential probe disposed within at least one of the inner wall and the outer wall,
wherein the at least one tangential probe is aligned at least partially tangentially.

13. The combustion system of claim 5 further comprising:
at least one expansion joint disposed at the inlet end of the combustor;
at least one outer cooling passage disposed at the outlet end; and
at least one inner cooling passage disposed at the outlet end;
the at least one air plenum further comprising:
an outer air plenum, wherein the at least one outer cooling passage fluidly connects the outer air plenum to an exterior of the combustor; and
an inner air plenum, wherein the at least one inner cooling passage fluidly connects the inner air plenum to an exterior of the combustor.

14. A combustion system comprising:
an annular tube disposed between an inner wall and an outer wall, the annular tube extending from an inlet end to an outlet end;
at least one fluid inlet disposed in the annular tube proximate the inlet end, the at least one fluid inlet providing a conduit through which fluid flows into the annular tube;
at least one outlet disposed in the annular tube proximate the outlet end;
at least one fuel injector disposed proximate the inlet end; and
at least one anti-coking feature disposed proximate the inlet end.

15. The combustion system of claim 14, the at least one anti-coking feature further comprising:
at least one circumferential plenum disposed circumferentially around the at least one fuel injector, the at least one circumferential plenum configured to receive at least one of fuel and air;
the at least one fuel injector further comprising at least one fuel plenum,
wherein air within the at least one circumferential air plenum cools fuel within the at least one fuel plenum.

16. The combustion system of claim 15, the at least one injector further comprising:
at least one air swirler disposed circumferentially around the at least one fuel plenum; and
at least one swirl fin disposed within the at least one air swirler.

17. The combustion system of claim 14, wherein the at least one fuel injector disperses fuel into a stream of inlet fluid entering the annulus at the at least one fluid inlet.

18. A combustion system comprising:
an annular tube disposed between an inner wall and an outer wall, the annular tube extending from an inlet end to an outlet end;
at least one fluid inlet disposed in the annular tube proximate the inlet end, the at least one fluid inlet providing a conduit through which fluid flows into the annular tube;
at least one outlet disposed in the annular tube proximate the outlet end; and
at least one mounting spring disposed proximate the outlet end.

19. The combustion system of claim 18, wherein the at least one mounting spring is disposed at least one of radially inward of the inner wall and radially outward of the outer wall.

20. The combustion system of claim 18, wherein the at least one mounting spring allows at least one of radial expansion of the outlet end and axial expansion of the outlet end.
